(19) United States
(12) Patent Application Publication
(10) Pub. No.: US 2003/0109406 A1
(43) Pub. Date: Jun. 12, 2003

(54) Storage stable concentrated cleaning solution

(76) Inventor: Edward M. Cooney, West Orange, NJ (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/188,239

(22) Filed: Jul. 2, 2002

Related U.S. Application Data
(60) Provisional application No. 60/303,002, filed on Jul. 3, 2001.
(60) Provisional application No. 60/365,066, filed on Mar. 7, 2002.

(51) Int. Cl. C11D 17/00; C11D 3/386

(52) U.S. Cl. 510/392; 510/421; 510/460; 510/530

(57) ABSTRACT

The invention provides a storage stable, non-corrosive cleaning solution composition that includes an enzyme system that includes at least one protease and at least one amylase. The cleaning solution is preferably prepared and stored as a concentrate, and optionally also includes at least one nonionic surfactant, a water-miscible solvent system, water, a system of enzyme stabilizers that includes a boron compound, and one or more inhibitors of metal corrosion, wherein the non-enzyme components are compatible with the enzyme system, and are water-miscible. Methods of making and using the composition are also provided

### FIELD OF THE INVENTION

The present invention relates to enzyme-based cleaning compositions for medical instruments. The inventive compositions include detergents or surfactants, enzyme cleaners, a solvent system, enzyme stabilizers, and corrosion inhibitors to provide enhanced cleaning capacity and storage stability, while inhibiting corrosive activity against metals.

### BACKGROUND OF THE INVENTION

In order to effectively disinfect and/or sterilize medical and dental instruments, including those for veterinary use, these instruments must be scrupulously cleaned to remove adherent foreign matter. This foreign matter includes, broadly, any undesirable materials remaining on the medical instruments and devices after these are employed during, e.g., a medical procedure. Once such materials become dried onto any surface, removal can be difficult. Further, such dried materials may form a resistant barrier and prevent adequate sterilization of those instruments. Previous to the availability of enzyme-based cleaning solutions, cleaning solutions were often based upon strong alkalis, such as lye or ammonia, or strong oxidizers, such as hypochlorites or peroxides, and the like. Obviously, these cleaners had many shortcomings, related, in part, to their corrosive effect on metals.

Current methods of pre-cleaning medical instruments involve rinsing the instrument with water or cleaning solutions immediately after patient use. The instruments are then soaked in an enzyme-based solution until delivery to a central cleaning area where the instruments are disinfected and sterilized, usually by an autoclave. The enzyme soaking solution keeps the instruments moist, in addition to digesting the material adhering to the instrument surfaces. Several commercially available enzyme-based medical instrument cleaners include include: ENZOL® from Johnson & Johnson Medical, Inc. (Arlington, Tex.) and OTHOZIME® marketed by the Ruhof Corporation (Valley Stream, N.Y.).

However, these cleaning solutions have a number of shortcomings, related to loss of enzyme activity during storage, and the still unsolved problem of corrosion of metal items subjected to prolonged contact or immersion in currently available cleaning solution. Further, neither of these products is known to include a boron compound, alone or in combination with other enzyme stabilizing agents such as calcium admixed with boron compounds and additional stabilizers for substantial improvement in storage stability of a liquid enzyme-based cleaner. For example, an enzyme-based cleaner that includes a boron compound is described by U.S. Pat. No. 4,261,868, incorporated by reference herein in its entirety. However, this patent fails to teach or describe the advantages resulting from a synergistic, stability promoting combination of a boron compound and calcium in ionic form, together with additional enzyme stabilizing agents as provided by the present invention.

There is also a continuing and longstanding need for liquid enzyme-based cleaners with substantial freedom from corrosion of metal or metal containing items or objects, after the long periods of immersion often required prior to final cleaning and/or disinfection process, as is required in medical settings.

Thus, there remains a long-standing need in the art for new and improved enzyme-based cleaning or pre-treatment cleaning solutions that can be stored for prolonged periods as a concentrate while retaining high levels of enzyme activity, and that does not cause significant corrosion of metals, such as brass and stainless steel, and that by stabilizing the enzyme content, is believed to reduce the likelihood of enzyme-induced skin reactions from contact with a concentrated enzyme-based liquid cleaning product.

### SUMMARY OF THE INVENTION

Accordingly, the present invention provides a storage stable, non-corrosive enzyme-based cleaning solution composition, that is preferably provided in the form of a concentrate. The cleaning solution composition includes an enzyme system, at least one detergent or surfactant, a water-miscible solvent system, water, an effective combination of enzyme stabilizers, and one or more inhibitors of metal corrosion. Optional components include perfumes and/or colorants to enhance appearance and odor of the cleaning solution. One or more pH sensitive indicators may also be included to warn of any undesirable pH change in the cleaning solution during storage or use. It should be appreciated that the non-enzyme components are compatible with the enzyme system, and are water-miscible.

The invention also provides for methods of making and using a cleaning solution concentrate. The cleaning solution concentrate is prepared by simply mixing the constituents into water, and stirring to ensure homogeneity.

In one preferred embodiment the concentrate is prepared by adding and mixing into water at least one detergent or surfactant, a water-miscible solvent system, at least one enzyme stabilizer and at least one inhibitor of metal corrosion. These are mixed into the water, preferably without aeration, until all materials are dissolved or dispersed, in any order suitable for effective dispersion into the water while retaining component activity.

In a more preferred embodiment, the concentrate is prepared as follows.

(a) Mixing into water, until dissolved or dispersed, a metal corrosion inhibitor, and then mixing into the resulting solution an additional compound that includes calcium ions , to form a further solution.

(b) Adding an alkanolamine to the solution to form a water-alkanolamine mixture, and mixing a boron-based compound into the water-alkanolamine mixture.

(c) Adding, in the following order, alkylene glycol, at least one surfactant, preferably having low foaming properties, at least one protease, at least one amylase and at least one alkanol, into the water-alkanolamine mixture, until all components are dispersed or dissolved, wherein the entire process is conducted with continuous, non-aerating mixing.

The invention further provides a method of cleaning or pre-cleaning medical instruments by contacting or immersing the instruments or other objects needing cleaning with an effective amount of the cleaning solution according to the invention. Cleaning solution is prepared from the above-described concentrate by diluting the concentrate with water. Preferably, the concentrate is diluted by a percentage ranging from about 85 to about 0.500 percent to provide a cleaning solution that is ready for use.

The treatment is conducted for a sufficient time to remove substantially all undesirable contaminating materials. Thereafter, the cleaning solution is removed from the treated instruments. Optionally, the instruments can remain immersed in the cleaning solution for as long as required before the instruments receive a final cleaning/rinsing and disinfection by autoclave, sterilizing chemical or irradiation, without producing significant corrosion of metal instruments or instrument components.

### DETAILED DESCRIPTION OF THE INVENTION

The present invention provides storage stable, enzyme-based, cleaning solution composition, preferably prepared as cleaning solution concentrates, that are stable in long term storage and that are readily diluted with water for use in virtually any application where enzymatic cleaning is desirable.

Applications where enzymatic cleaning is desirable include the cleaning or pre-soaking of items or objects with metal parts or components that must be cleaned to remove organic or biological materials. In brief, these include items or objects employed in the medical, dental, veterinary, professions, and in research and service facilities related to such professions. A summary of the myriad such items includes e.g., instruments and devices for surgery, therapy, diagnosis and testing.

Other items benefiting from the inventive cleaning solutions and cleaning methods include items or objects employed in the food processing and pharmaceutical industries, such as instruments and devices for processing materials derived, e.g., from animal or horticultural sources. The inventive cleaning solutions are also of potential benefit for cleaning objects employed in the grooming of people, pets and domestic animals, e.g., instruments for tatooing, haircutting, nail grooming, and the like.

In addition to the above-mentioned advantages, the inventive cleaning solution is substantially non-corrosive to metals such as steel, which are often at risk of rusting when soaked in previously available cleaning products. A further advantage of the inventive cleaning solution is its improved safety. While not wishing to be bound by any particular theory or hypothesis as to how certain features of the invention might operate, it is believed that the stability enhancing components render the enzyme system substantially inactive. This is also believed to reduce the potential hazards from skin contact with the inventive cleaning solution concentrate, e.g., the allergic reactions sometimes reported from handling enzyme-based cleaning products.

The main active ingredients for cleaning include an enzyme system, at least one detergent or surfactant, and a water-miscible solvent system. The cleaning solution provided by the invention can be used for any suitable purpose. Preferably, it is employed as a soak cleaner for medical and surgical instruments, dental hand piece, and the like, for both human and veterinary practice. When used as a soak cleaner, it is applied before the instruments are sterilized. It can also be readily employed as a concentrate to be added to an automatic cleaning or circulating machine, for cleaning more elaborate medical equipment.

When employed in automatic washing systems, it is important that the detergent or surfactant component have low foam characteristics to avoid machine malfunction due to excessive foam formation. The inventive cleaning solution is readily employed at elevated temperatures, as high as about 40° C.

For purposes of the present invention, the use of the singular or plural is not meant to be limiting of the numerical number of the referenced item or object. Thus, the use of the singular to refer to an object, reagent, enzyme or the like, does not imply that only one object is treated, only one reagent is employed, and/or only one enzyme is employed. The use of the plural does not exclude application to a single referenced item, unless expressly stated. For purposes of the invention, the terms, “detergent,” and “surfactant” are used interchangeably, unless otherwise indicated.

Foreign matter to be cleaned or removed includes, simply by way of example, biological substances, e.g., tissue and blood. Foreign matter also includes other materials such as lubricant, diagnostic and therapeutic compositions, materials for pathology testing, medical or veterinary research, and the like, remaining on medical instruments and devices after these are employed for their intended use, and may also be referred to herein as “soil” or “soils.”

The term “medical instrument,” whether singular or plural, is intended to be defined broadly, to include any items, objects, implements or devices for which the non-corrosive removal of organic or biological substances, such as protein, fats, carbohydrates and similar material is desirable. Simply by way of example and without limitation, medical instruments are implements employed in patient or client contact (human or veterinary) during the practice of surgery, medicine, dentistry, podiatry, pathology for e.g., therapeutic, diagnostic and/ or research purposes. Examples include, surgical instruments, e.g., scalpels, probes, clamps, etc., endoscopes, operating room or dental handpieces, ventilation tubes, and the like.

Other implements and devices that benefit from the inventive cleaning solution also include miscellaneous other instruments and/or implements employed in cosmetic and beauty applications. These applications include hair cutting, nail care, body art, skin piercing, collection of body fluids, e.g., blood, and blood separation and fractionation equipment, and similar such applications, that are too numerous to mention. The inventive cleaning solutions are also contemplated to be useful for cleaning implements and items employed in the food processing and pharmaceutical industries. These include implements and equipment used for the production of meat and milk from domestic animals, implements and equipment used for research and production related to health care, purified proteins, and especially those implements and equipment that might be damaged by extreme temperatures during cleaning.

The enzyme system includes, without limitation, a protease and an amylase. The purpose of the enzyme system is to break down adherent proteinaceous and polysaccharide materials typically found on medical instruments after use, into forms that are readily dispersed into a water-based wash solution. These adherent materials can be very difficult to remove using only detergents and solvents. Proteins and polysaccharide films left in or on implements such as medical instruments that cannot be mechanically scrubbed, can protect microbes against chemical sterilizing agents or methods that are applied to the instruments after use. In addition, the organic load left on an instrument is well known to deplete any chemical sterilizing agent, thus reducing the number of items that can be sterilized in each batch of agent.

Any protease or mixture of proteases, from any source, can be employed in the enzyme system of the invention, provided that the selected enzyme system is stable in the desired pH range and compatible with the inventive composition. While the enzyme may be obtained commercially in a solid or liquid form, the liquid form is preferred for greater convenience in dispersing the enzyme during preparation of the concentrated cleaning solution of the invention.

Preferred protease enzymes are stable in an alkaline pH range, and are obtained from bacterial strains, and have sufficient activity per gram of enzyme protein, to economically solubilize and remove proteins from medical instruments during the desired cleaning cycle. The measured activities of enzymes, such as proteases, are dependent on their source, purity and assay conditions. The enzyme activity of proteases is described in units which relate to the method of enzyme analysis used.

One art-known way in which the desired activity is expressed is in the form of Novo units, or Kilo Novo Units (“KNPU”) /gram of enzyme protein, based on a procedure as published by Novozymes of North America (Frankington, N.C.) under reference No. B 1152a-GB. Other art-known protease activity units are mentioned simply for completeness, and include, e.g., Glycine Units (GU), Delft Units (DTJ), Showa Denko Protease Units (PU), casein digestion units (CDU), Showy Denko Units (SU), and Ansor-units (AU). A preferred protease activity range in Novo units ranges from about 0.10 kilo KNP/gram to about 0.48 KNP/gram, or more. A more preferred protease activity range in Novo units ranges from about 0.30 kilo KNP/gram to about 0.48 KNP/gram, or more.

Suitable protease enzymes are, for example, the enzymes obtained from Bacillus subtilis, Bacillus licheniformis and Streptomyces griseus, to name but a few such organisms. More preferably, the enzyme is one or more of the commercially available serine endoproteases. These enzymes preferably cleave protein links on the carboxyl side of hydrophobic amino acid residues, but are capable of cleaving most peptide links. They convert their substrates into small fragments that are readily dissolved or dispersed into a wash solution.

For example, there are commercially available proteases that are derived from B. clausii, that can be used in temperatures ranging from about 10 to about 65° C. and at an alkaline pH range, e.g., ranging from about pH 7 to about pH 13, and more particularly from a pH ranging from about 7 to about 10.5. A preferred protease is commercially available under the trade name of SAVINASE® 16L Type EX, with an activity reported as 16 KNPU/gram from Novozymes (North Carolina and Denmark). Other available proteases include, ALCALASE® 2.5L and DURAZYME® 16.OL, also available from Novozymes, as described above.

Another commercially available protease is ALKAPRO® from Geo. A. Jeffreys & Co., Inc (Salem, Va.), that is sold as an alkaline serine-type protease of bacterial origin, having an enzyme activity of at least 400,000 casein digestion units (“CDU”)/gram.

Amylases are also contemplated to be included in the cleaning solution of the invention for solubilizing or dispersing complex carbohydrate-based foreign materials from medical instruments to be cleaned. Amylase enzymes can be obtained from any suitable source, such as bacterial strains, barley malt, certain animal glandular tissues and any others known to the art. Preferred amylase enzymes are stable in an alkaline pH range, and are obtained from bacterial strains, and are sufficiently active per gram of enzyme protein to economically solubilize and remove complex carbohydrates from medical instruments during the desired cleaning cycle. Preferred types of amylases include those which are referred to as alpha-amylases, beta-amylases, iso-amylases, pullulanases, maltogenic amylases, amyloglucosidases, and glucoamylases, as well as other amylases enzymes not particularly elucidated here. These include also endo- and exo-active amylases.

Preferably, the employed amylase enzymes exhibit from about 0.5 Kilo Novo (“KN”) units/ gram to about 3 KN units/gram, or more, based on a procedure as published by Novozymes North America (Frankington, N.C.) under Novozymes reference No. B309d-GB (Copenhagen, Denmark), incorporated by reference herein. More preferably, the employed amylase enzyme(s) range in activity from about 1.5 Kilo Novo (“KN”) units/ gram to about 3 KN units/gram, or more, In particular, amylase enzymes produced by Bacillus licheniformis, expressing a recombinant Bacillus sterothermophilus gene for alpha amylase, and Bacillus acidopullulyticus, are preferred. One commercially available amylase enzyme product that is preferred is derived from B. licheniformis and is available under the trade name TERMAMYL® from Novozymes North America (Frankington, N.C.).

It will be appreciated that additional enzymes are optionally included in the enzyme system of the invention, depending upon the nature of the materials or soils to be removed. Thus, lipases, ccllulases, pectinases, carbohydrases, beta-gluconases, himcullulases, and xylanases, and others too numerous to mention are included in the enzyme system as required. Such additional enzyme are optionally combined with, or substituted for, the above-mentioned protease or amylase enzymes.

The enzyme-based aqueous cleaning compositions of the invention further comprise a nonionic detergent or surfactant. It has been found that nonionic surfactants advantageously provide enhanced cleaning effectiveness when included in the compositions. The detergency is important not only for general removal of undesirable foreign matter, but for the emulsification of any lipid based soil which increases the ability of the enzymes to act on the soils. The nonionic nature of the surfactant also makes it compatible with enzymes.

In one embodiment, useful nonionic surfactants include, e.g., those with hydroxyl, ether, amine oxide, phosphine oxide, sulphoxide, propargyl, ester, or amide functionalities. Among these, ethoxylates are considered especially useful, and these include, for instance, alcohol ethoxylates, mono alkanolamide ethoxylates, fatty amine ethoxylates, fatty acid ethoxylates, ethylene oxide/propylene oxide copolymers, and alkyl phenol ethoxylates. Further exemplary useful nonionic surfactants include multiple hydroxyl molecules such as glucosides, glyeerides, glycol esters, glycerol esters, polyglycerol esters and polyglyeerides, polyglycosides, sorbitan esters and sorbitan ester ethoxylates, and sucrose esters.

Desirably, the one or more nonionic surfactants are those known to have reduced foaming characteristics, as excessive foaming of the inventive compositions may reduce the overall cleaning efficacy of the compositions. Excessive foaming is desirably avoided, especially where the present compositions are intended to be utilized in machinery or devices which aid in, or which perform in the cleaning of instruments, etc. For cleaning solutions employed, e.g., in hand-washing applications, a detergent with low foaming properties is optional.

In a further embodiment, preferred nonionic surfactants are the ethylene oxide/propylene oxide copolymers, There are many possible variations within this class, among the most useful being of three types. The PLURONIC® copolymers having the formulas (EO)n(PO)m(EO)n, where EO is ethylene oxide, PO is propylene oxide, n is an integer ranging from 1 to about 20,000, and m is an integer ranging from 1 to about 20,000; the reverse PLURONIC copolymers having the formulas (PO)n(EO)m(PO)n, with the same abbreviations as above; and the EO/PO copolymers with alkyl end group on one or both ends. The copolymers above are represented as block copolymers, although random copolymers are also useful in the compositions according to the invention. It should be noted that even those copolymers commercialized as block copolymers will have some degree of randomness. Glycerol-based EO/PO block mid random copolymers and ethylene aliamine-based block and random copolymers are also useful in the compositions according to the invention. Useful information on nonionic surfactants is found, for example, in The Handbook of Surfactants, M. R. Porter, (Blackie Academic and Professional, 1994, London) incorporated herein by reference.

A particularly preferred embodiment includes, e.g., the EO/PO block copolymers commercially available as PLURONIC surfactants (BASF). The nonionic surfactant is desirably present in an mount of from about 1% to about 20% by weight, more desirably from about 2.5% to about 10% by weight, and most desirably from about 5% to about 110% wt. based on the total weight of the composition of which it forms a part.

The solvent system includes polyhydroxy-containing compounds such as alkylene glycols. Alkanols, polyhydroxy-compounds, such as alkylene glycols, and alkanolamines, are known to be both enzyme stabilizers, as well as useful carriers and solvents.

Polyhydroxy-compounds that are readily employed are those in the class of alkylene glycols such as ethylene glycol, propylene glycol, as well as glycerine. While not wishing to be bound by any particular theory or hypothesis as to how one component of the invention might operate, polyhydroxy-compounds are believed to promote stabilization of enzymes in aqueous medium by sequestering water molecules which otherwise tend to lead to enzyme destabilization. These materials are widely available from general chemical suppliers such as Aldrich Chemical Co. (St. Louis, Mo.). The polyhydroxy-containing compound is preferably present in an amount of from about 10% to about 30% by weight, or mare preferably, from about 10% to about 20% by weight of the cleaning solution concentrate.

The enzyme-based aqueous cleaning solution concentrate of the invention preferably includes at least one alkanol component that is soluble or miscible with water and lipids, and that is a hydrotroph, and includes, e.g., an alkyl group that is straight or branched, substituted or non-substituted, and the alkyl can include, for example, from 1 to about 10 carbons, and more preferably from about 3 to about 7 carbons in length.

Useful alkanols include short chain alcohols, such as C₁-C₈ primary, secondary and tertiary alcohols, e.g., methanol, ethanol, n-propanol, iso-propanol, and butanol, Particularly preferred alkanols include the various isomers of C₃ alcohols, particularly iso-propanol. C₁-C₈ diols may also be used in the alkanol constituent. The alkanol is present in a suitable concentration, generally ranging from about 2 to about 10 percent, by weight, relative to the weight of the concentrate. Preferably, the alkanol concentration ranges from about 3 to about 10% by weight, and/or from about 7% to about 10%, by weight, of the enzyme-based aqueous cleaning compositions, i.e., the concentrate according to the invention.

In addition to the alkylene glycols and alkanolamines having functions that include enzyme stabilization, additional enzyme stabilizers are provided.

Thus, the enzyme-based aqueous cleaning compositions of the invention further comprise calcium ion which is believed to enhance the stability of the enzymes present. The calcium ions are desirably present as water-soluble salts, such as the halide salts, including calcium chloride. The calcium ion concentration ranges from about 0.01% wt, to less than about 2.0% by weight. In a preferred embodiment, the calcium ion concentration ranges from about 1.0% by weight to about 0.05% wt.

In certain further preferred embodiments calcium chloride is employed in combination with a compound of boron. Boron compounds preferably included as enzyme stabilizers include those that are water soluble, such as boronic acids having a formula of

RB(OH)₂

wherein R is alkyl or aryl, substituted or non-substituted.

When R is alkyl, R preferably ranges in size from C₁ to about C₄; R is optionally substituted with hydroxyl, amino, or carboxyl groups as desired to modify the solubility of the boron-containing compound. Also useful is boric acid, B(OH)₃. Polyborates which can be formed in situ or added as a species are also optionally included in the inventive compositions. Such polyborates include species having molecular formulas of:

B₃O₃(OH)₄; B₃O₃(OH)₃²⁻; B₅O₆(OH)₄; B₄O₅(OH)₄²⁻, and including the borate B(OH)₄.

These are generally present as their alkali metal sales. In addition, hydrated forms of alkali metal borates, such as Borax are optionally employed. Further optional boron compounds useful in the inventive composition include boron oxides. Preferred boron-containing compounds are boric acid and alkali metal borates, and The boron-containing compound is desirably present in an mount of from about 0.2% to about 10% by weight, or more desirably, from about 2% to about 5% by weight of the composition.

The enzyme-based aqueous cleaning compositions of the invention further comprise an alkanolamine. The alkanolamine is useful in the compositions according to the invention for two reasons: to adjust the pH of the material, and to provide enhanced cleaning benefit, e.g., by cutting lipid based materials to be removed, while remaining enzyme compatible. The enzyme-based aqueous cleaning solution concentrates preferably have a pH ranging from about pH 7 to about pH 8 and more preferably from about pH 7.3 to about pH 7.7. Alkanolamines also serve as a buffer to keep the pH of the cleaning solution at around pH 7.5.

Preferred alkanolamines include, e.g., monoalkanolamines, dialkanolamines, trialkanolamines, and alkylalkanolamines, such as alkyl-dialkanolamines, and dialkyl-monoalkanolamines or combinations thereof. The alkanol and alkyl groups are generally short to medium chain length, that is, from 1 to 7 carbons in length. For di- and trialkanolamines and dialkyl-monoalkanolamines, these groups can be combined on the same amine to produce for example, methylethylhydroxylpropylhydroxylamine, to name but a few such possibilities.

Preferred alkanolamines are trialkanolamines, including triethanolamine.

Alkanolamine is desirably present in an amount of from about 1% to about 10% by weight, or more particularly from about 3% to about 5% by weight of the composition.

The enzyme-containing aqueous cleaning solution concentrates of the invention further include water sufficient to provide the remaining weight of the composition. Deionized or distilled water is preferably employed.

According to certain particularly preferred embodiments the inventive cleaning solutions are provided the above-described concentrated form and retain a significant proportion of their initial enzymatic activity during long term storage, e.g., at elevated temperatures. Preferably, the inventive compositions retain at least 50%, more preferably at least 60%, even more preferably at least 70% and still more preferably at least 75% of their initial enzymatic activity following storage of 7 days at 50 degrees C. Still more desirable embodiments of the invention, as exemplified hereinbelow, retain from 50 to 90% of their initial enzymatic activity during storage periods ranging from 12 weeks through 1 year, or more, even when stored at elevated temperatures, e.g., at temperatures ranging from 40 through 120 degrees C.

The compositions described herein are therefore preferably provided as concentrated stock solutions. When needed, these are preferably diluted into a larger volume of water to form a “working” enzyme cleaning composition. Dilutions will vary as required by the cleaning situation, and can range from, e.g., 1 part of the inventive composition to from 10-500 parts of water. More preferably, the dilutions can range from 1 part to from 20-250 parts of water. As exemplified herein, dilutions of 1 part to about 128 parts of water are generally most preferred.

Further optional components include corrosion inhibitors, perfumes, colorants, and the like. Preferred corrosion inhibitors include, e.g., COBRATEC 99, a Corrosion inhibitor for brass, available from PMC Specialties Group.

Table 1, provided below, shows the preferred components that are described in the Examples, and indicates the preferred range of weight percentages for those components, relative to the total weight of the final product.

TABLE 1

| | Min/Max Ranges | |
|---|---|---|
| Ingredients | Min.** | Max.** |
| D.I.* Water | 66.850 | 58.850 |
| COBRATEC 99¹ | 0.050 | 0.20 |
| Caltac FCC Gran Anhydrous² | 0.100 | 1.00 |
| Enzyme stabilizer | | |
| Triethanolamine 99³ | 1.000 | 7.00 |
| Boric Acid Tech. Granular⁴ | 1.000 | 5.00 |
| Propylene Glycol USP⁵ | 5.000 | 20.00 |
| PLURONIC L62LF⁶ | 1.000 | 10.00 |
| Isoropanol⁷ | 2.000 | 10.00 |
| Cleaning solvent, Formula stabilizer | | |
| SAVINASE 16.0 - L Ex. Protease⁸ | 0.500 | 10.00 |
| TERMAMYL 300 Amylase⁸ (300 KN units/g) | 0.100 | 10.00 |
| Dye | 0.000 | 0.01 |
| Perfume | 0.050 | 0.50 |
| Totals | 77.650 | 132.560 |

*deionized
**% by wt.
¹Corrosion inhibitor for brass; PMC Specialties Group
²CaCl₂; Mallinckrodt, Inc.
³Dow Chemical; Cleaning solvent, pH adjuster
⁴US Borax Co.; Enzyme stabilizer
⁵Lyondell Chemical; Cleaning solvent, Enzyme stabilizer
⁶BASF Co.; Surfactant
⁷EM Science
⁸Novozymes/Novo Nordisk Co.

The following Examples are provided to illustrate the invention but are not meant in any way to restrict the effective scope of the invention.

### EXAMPLE 1

### PREPARATION OF FORMULAS 1-4 of ENZYME-BASED CLEANING SOLUTION CONCENTRATES

Cleaning solutions concentrates designated as Formulas 1, 2, 3 and 4 were prepared using the components listed in Table 2, below, that were combined by the following method.

The weight percentages for each component of the exemplified concentrate compositions are shown by Table 2, below. The specified amount for each respective formulation was added to deionized water in a beaker. Continuous, non-aerating mixing, was started, and COBRATEC 99 was added to the water and allowed to dissolved completely. The calcium chloride was added next and allowed to dissolve. Then the triethanolamine was added to the mixture, followed by the boric acid, which was also allowed to dissolve in the continuously stirring mixture. The following additional materials were then added, in the order in which they are listed: propylene glycol, PLURONIC L62LF, SAVINASE 16.0L, TERMAMYL 300, isopropyl alcohol, dye, and perfume, all in the amounts shown by Table 1. Mixing was continued for two more minutes after the final addition.

TABLE 2

| | Formula 1 | | | |
|---|---|---|---|---|
| | Finished | | | |
| | Rx | Formula 2 | Formula 3 | Formula 4 |
| Ingredients | % by wt. | % by wt. | % by wt. | % by wt. |
| D.I. Water | 58.596 | 66.850 | 58.850 | 56.596 |
| COBRATEC 99¹ | 0.100 | — | — | 0.100 |
| Caltac FCC Gran | 0.200 | 0.200 | 0.200 | 0.200 |
| Anhydrous² | | | | |
| Enzyme stabilizer | | | | |
| Triethanolamine 99³ | 5.000 | 5.000 | 5.000 | 5.000 |
| Boric Acid Tech. | 3.000 | 3.000 | 3.000 | 3.000 |
| Granular⁴ | | | | |
| Propylene Glycol USP⁵ | 15.000 | 15.000 | 15.000 | 15.000 |
| PLURONIC L62LF⁶ | 6.450 | 6.450 | 6.450 | 6.450 |
| Isoropanol⁷ | 8.000 | — | 8.000 | 8.000 |
| SAVINASE 16.0 - L Ex. | 3.000 | 3.000 | 3.000 | 5.000 |
| Protease⁸ | | | | |
| TERMAMYL 300 | 0.500 | 0.500 | 0.500 | 0.500 |
| Amylase⁸ | | | | |
| Dye | 0.004 | — | — | 0.004 |
| Perfume | 0.150 | — | — | 0.150 |
| Total | 100.000 | 100.000 | 100.000 | 100.000 |

¹Corrosion inhibitor for brass; PMC Specialties Group.
²CaCl₂; Mallinckrodt, Inc.
³Dow Chemical; Cleaning solvent, pH adjuster.
⁴US Borax Co.; Enzyme stabilizer.
⁵Lyondell Chemical; Cleaning solvent, Enzyme stabilizer
⁶BASF Co.; Surfactant.
⁷EM Science; Cleaning solvent, Formula stabilizer
⁸Novozyme of North America (300 KN units/g)

### EXAMPLE 2

### ENZYME-BASED CLEANING SOLUTION CORROSION TEST

The following tests were conducted to confirm that the enzyme-based cleaning solutions of Example 1 are compatible with metals commonly used in medical instruments.

A. Materials and Methods

Working solutions of the concentrated enzyme-based cleaning solutions of Example 1 were prepared by dilution with water. Working solutions of two commercially available enzyme-based cleaning solutions were also prepared.

The corrosion tests were conducted on metal coupons, which were cut to 1 inch×2 inch×⅛ inch. Each coupon was cleaned and then placed into a beaker containing the a test cleaning solution. The coupons were placed in the beakers so that ¾ of the coupon was submerged and ¼ was above the solution surface. The coupons were left to soak at 25° C. for 24 hours. At the end of the soaking, the coupons were rinsed and dried in a manor not to effect any corrosion that may have formed on the coupons. The amount and type of corrosion was recorded for each coupon.

ENZOL™ is a product of Johnson & Johnson, as noted supra.

OTHOZIME™ is a product of Ruhof, as noted supra.

B. Results:

Table 3, provided below, tabulates and summarizes observations made on the various types of metal coupon after 24 hours of immersion in the three test solutions and the water control. The reported results are based on observation of the portion of each metal coupon that was submerged in the solutions or the water control and, when corrosion was present, the corrosion is expressed, e.g., as a percentage of the submerged surface that is rusted/discolored.

TABLE 3

| | CLEANING SOLUTIONS TESTED | | | |
|---|---|---|---|---|
| Metal Type | Formula 1¹ | Tap Water² | ENZOL³ | ORTHOZIME⁴ |
| (Coupon) | Observations on Condition of Submerged Surface Area | | | |
| Steel | One very small rust | 90% coated | 100% coated | 100% coated |
| SAE 1010CR | spot, pin point size | with rust | with rust | with rust |
| Steel | One very small rust | 100% coated | 100% coated | 100% coated |
| SAE 302A | spot, pin point size | with rust | with rust | with rust |
| Stainless Steel | No Corrosion | No Corrosion | No Corrosion | No Corrosion |
| 316 | | | | |
| Brass CA260 | No Corrosion | 80% has light | No Corrosion | No Corrosion |
| | | discoloration | | |

¹Concentrate diluted by H₂O 1:128 (0.775%); Varied from Ex. 1 with a different perfume.
²100% H₂O (Control)
^{2,3}Concentrate diluted by H₂O 2:128, per label.

C. Conclusion

As can be appreciated from the results and observations as summarized by Table 3, the comparison data confirm that the inventive enzyme-based cleaning solution produces substantially less corrosion on surfaces after 24 hours of immersion in the tests conducted on two kinds of (non-stainless) steels. This represents an improvement of nearly 100% in the protection of these types of steel from corrosion, relative to the corrosion produced by the ENZOL AND OTHOZIME enzyme-based cleaners.

### EXAMPLE 3

### ENZYME-BASED CLEANING SOLUTION ACTIVITY TEST

The following test was done to determine the activity of the enzyme-based cleaning solution as a concentrate and at different dilutions with water to determine the optimum concentration of a working solution. The test was conducted using commercially available X-ray film, which is coated with an opaque protein emulsion as a test substrate for protease enzyme activity of different cleaning solution preparations.

A. Materials and Methods

Strips of X-ray film were cut to the dimensions of 4 inches long by ⅜ inches wide and then marked every ⅜ inch in the four inch direction.

Dilutions of Formula 1 of the concentrated enzyme-based cleaner were prepared in varying concentrations, ranging from 100% to 0.775% in steps as shown by Table 4, below. Each diluted working solution was placed into a beaker, and for each respective dilution, a strip of the marked X-ray film was hung above the beaker.

At timed intervals of 1.5 minutes, all the strips were lowered ⅜ inch farther down into the respective solutions, and this process was repeated until 9 minutes from the start of the test. At 9 minutes, all the strips were removed from the beakers, and immediately rinsed with room temperature water. The strips were than air dried. After drying, the strips were evaluated for transparency, and the time interval in which the strip had cleared was recorded.

B. Results

Commercially available X-ray film is manufactured with an opaque emulsion coating that is conveniently made of a protein material. Since the X-ray film is a standardized product dispensed in rectangular sheets, it is a convenient way to test for protease activity. Soaking X-ray film in an aqueous solution having protease enzyme activity will, after a suitable time period, result in the removal of the protein emulsion from the film, leaving behind the clear plastic film substrate. The speed of this process is determined by the concentration of the enzyme solution and the length of time the film is exposed to the enzyme solution. The results are summarized below by Table 4.

TABLE 4
Solution Activity

| Time | Concentration (%) | | | | | | | | | | |
|---|---|---|---|---|---|---|---|---|---|---|---|
| (Min.) | 100 | 95 | 90 | 85 | 75 | 60 | 45 | 30 | 15 | 5 | 0.775 |
| 0.0 | no | no | no | no | no | no | no | no | no | no | no |
| 1.5 | no | no | no | no | no | no | no | no | no | no | no |
| 3.0 | no | no | no | no | no | yes | yes | yes | yes | yes | no |
| 4.5 | no | no | no | no | no | yes | yes | yes | yes | yes | no |
| 6.0 | no | no | no | no | no | yes | yes | yes | yes | yes | no |
| 7.5 | no | no | no | no | yes | yes | yes | yes | yes | yes | yes |
| 9.0 | no | no | no | yes | yes | yes | yes | yes | yes | yes | yes |

no = film not cleared, yes = filmed cleared

C. Conclusion

Table 4 shows that at the higher concentrations the diluted enzyme-based cleaning solution did not clear the film, therefore the protease activity was very low. For concentrations approaching a dilution of about 85%, the protease enzyme activity was higher. The cleaning solution reached its maximum activity with dilutions between 60% and 5%. While not wishing to be bound by any theory or hypothesis as to how the invention might operate, it is believed that this is due to the reduction in the concentration of the several enzyme stabilizers in the solution with each dilution step. The lower the concentration of stabilizers, the more active the protease enzyme. Since the protease enzymes having a broad substrate specificity are self-hydrolyzing, particularly at higher concentrations, this effect is believed to contribute to the greatly prolonged storage stability of the concentrated cleaning solution of the invention.

### EXAMPLE 4

### 16 WEEK STORAGE STABILITY TESTING OF CLEANER CONCENTRATE

The stability of the enzyme system during storage of Formula 1 prepared in Example 1, above, was tested by measuring enzyme activity of Formula 1 during storage over a period of 16 weeks.

A. Material and Methods

Samples of Formula 1 were stored at 25, 40 and 48 degrees C., respectively. The Formula 1 samples that were stored at 25 and 40 degrees C. were followed for a four week period, and the concentrate stored at 48 degrees C. was assayed for a 16 week period, for the included SAVINASE 16L and TERMAMYL 300L enzyme activity.

These assays were conducted by Novo Nodisk of North America and were measured by their methods TM3024 and TM3046, respectively.

B. Results and Conclusions

The level of activity present at the start of the testing was defined as 100% activity for both the SAVINASE 16L and TERMAMYL 300L activity determinations.

The SAVINASE 16L protease enzyme activity retained approximately 100% of the original activity, within the margin of error, for four weeks in samples of Formula 1 stored at 25 and 40 degrees, respectively (data not shown). The samples of Formula 1 stored at 48 degrees C. retained about 95% of the original activity for 14 weeks (data not shown).

The TERMAMYL 300L amylase enzyme activity retained approximately 100% of the original activity, within the margin of error, for four weeks in samples of Formula 1 stored at 25 and 40 degrees, respectively (data not shown). The samples of Formula 1 stored at 48 degrees C retained about 90% of the original activity for 4 weeks (data not shown) and the remaining activity declined in an approximately linear fashion between 4 weeks and 16 weeks, reaching about 60 percent of the original amylase enzyme activity at 16 weeks of storage.

Storage stability testing at elevated temperatures is an art-known way of obtaining a more rapid determination of product stability that can be expected to result with storage at room temperature, e.g., typically closer to 25 degrees C. in the non-tropical regions of the world. The above described results confirm an unexpected degree of stability during storage at both room temperature and especially at elevated temperatures for the activity of the enzyme systems included in the concentrated form of the inventive cleaning formula. The storage stability during the 16 weeks at 48 degrees C. is estimated to indicate a good normal shelf-life for the concentrated form of the inventive cleaning formula exemplified by Example 1.

### EXAMPLE 5

### ONE YEAR OR MORE STORAGE STABILITY TESTING OF CLEANER CONCENTRATE

Stability data was obtained with a composition of Formula 1, according to Example 1, differing only in that it included a different perfume than shown in Example 1.

Table 5, below, confirms the stability of the enzyme as measured over time for product stored at a range of temperatures. The activity of the formulation during storage was measured as a function of the time that was required for the tested product to remove the opaque coating from the test film strip, 1 as described in greater detail in the above provided examples. Table 5 records this as the “clear time.” Longer clear times indicate reduced product activity.

TABLE 5
Soak time to clear test strips (min.) verses Months in Storage

| Time | Storage Temp | | | | Freeze/ |
|---|---|---|---|---|---|
| (Months) | 40° F. | 77° F. | 105° F. | 120° F. | Thaw |
| 0 | 5 | 5 | 5 | 5 | 5 |
| 1 | 10 | 10 | 10 | 10 | 10 |
| 2 | 10 | 10 | 10 | 10 | — |
| 3 | 10 | 10 | 10 | 12.5 | — |
| 4 | 10 | 10 | 7.5 | 10 | — |
| 6 | 10 | 10 | 7.5 | 12.5 | — |
| 12 | 7.5 | 7.5 | 7.5 | >15 | — |

Table 5 confirms that even after extended storage periods of up to 12 months, at temperatures ranging from 40 to 105° F., the protein emulsion on the indicator X-ray film was cleared by the stored cleaning solution in less than 13 minutes for all samples.

The above data confirm that the inventive composition provides extended storage sability for the cleaning solution concentrate. The samples stored at 40° F.,77° F. and 105° F. maintained their full protein clearing activity beyond 12 months. The data also confirms that the 120° F. sample began to loose activity at about 6 months, and by 12 months has taken more time to clear the film than allowed for the test interval. For an enzyme stored at 120° F., this is extremely good stability.

### EXAMPLE 6

### STORAGE STABILITY RELATIVE TO - RUHOF ENDOZIME

Stability data was obtained with a composition of Formula 1, according to Example 1, comparing the activity of fresh Formula 1, three month old Formula 1 and three month old Ruhof ENDOZIME cleaner, at two different dilutions.

Table 6, below, confirms the stability of the protease enzyme, which is the main active component of Formula 1. The stability was measured over time for product stored at arrange of temperatures.

TABLE 6
Protease Activity of Formula 1 at 3 Months verses
Ruhof ENDOZIME Stored for Three Months

| | Ruhof Endozime | Ruhof Endozime | | | Form. 1 |
|---|---|---|---|---|---|
| | AW | AW | Form. 1 | Form. 1 | Stored 3 Months |
| Dilutions: | 1:128 | 1:256 | 1:128 | 1:256 | 1:256 |
| Soak (Min.) | | | | | |
| 0 | No | No | No | No | No |
| 2.5 | No | No | No | No | No |
| 5 | No | No | No | No | No |
| 7.5 | No | No | Yes | No | No |
| 10 | No | No | Yes | No | No |
| 12.5 | No | No | Yes | No | No |
| 15 | No | No | Yes | Yes | Yes |

No = film not cleared, Yes = filmed cleared

Table 6 confirms that that the inventive formula provides improved storage stability relative to a previously available commercial product.

### EXAMPLE 7

### REMOVING BLOOD AND EGG

The following test method was used to confirm the efficacy of the inventive cleaner for the medical industry. First, a test soil was made from 90% wt egg yolk and 10% wt lamb's blood, which were mixed to form a homogenous mixture. This mixture was made within an hour of application to the test (stainless steel) coupons described below. This combination of materials was chosen because the egg yolk and lamb's blood contain the lipids and proteins which exemplify difficult types body/medical waste to be enzymatically cleaned

Next, a series of 1 inch (2.5 cm) by 2 inch (5.1 cm,) stainless steel coupons, one eighth inch thick, with a one eighth inch (0.32 cm) hang hole at the top, were cleaned and dried. The coupons were dipped in the test soil to cover 90% of the surface of each coupon.

The dipped coupons were then hung to dry at 25° C. for 24 hours. After drying, the weights of the soiled coupons were recorded as the initial un-cleaned weight. Subsequently, diluted samples of enzymatic cleaning compositions, including samples prepared according to Example 1, above, were produced and placed into beakers large enough to submerge the soiled sections of the stained coupons. These diluted samples of cleaning composition were 1:128 w/w dilutions of an enzymatic cleaning composition in a larger volume of deionized or distilled water. The enzymatic cleaning compositions used to form the diluted samples had been formed two months prior to the present: test and had been stored, at the various temperatures indicated in Table 7, below.

The coupons were hung in the samples for a measured time period (20 min.) and then removed. On removal from the cleaning solution, the coupons were rinsed at a faucet in a stream of water. The water was at a temperature of 25° C., and was flowing at a rate of 66.67 ml/sec. The coupons were held at approximately a 30° angle to the stream of water, 3 inches from the faucet, and were passed through the stream three times on each side so that the entire coupon had been rinsed. The coupons were then hung to dry for 24 hours at 25° C. After drying, the coupons were weighed and compared to the initial weights, to determine the weight loss due to soil removal. The results are listed in Table 7.

TABLE 7

| Formula No. [Storage Temp.] | Wt of soil loss |
|---|---|
| Formula 2 [40° F.] | 0.075 grams |
| Formula 2 [77° F.] | 0.075 grams |
| Formula 2 [105° F.] | 0.075 grams |
| Formula 3 [120° F.] | 0.074 grams |
| Water only | 0.009 grams |

The results provided above confirm that the 1:128 dilution of the inventive cleaning solution concentrate is highly effective in removing dried proteins and fats from stainless steel.

A number of publications, patents, patent applications and other documents are mentioned in this application and all of these are hereby incorporated by reference herein.

While there have been described what are presently believed to be the preferred embodiments of the invention, those skilled in the art will realize that changes and modifications may be made without departing from the spirit of the invention. It is intended to claim all such changes and modifications as fall within the true scope of the invention.

What is claimed is:

1. A storage stable cleaning solution composition comprising an enzyme system, at least one nonionic surfactant, a water-miscible solvent system, water, a system of enzyme stabilizers that comprises a boron compound, and one or more inhibitors of metal corrosion, wherein the non-enzyme components are compatible with the enzyme system and are water-miscible.

2. The cleaning solution composition of claim 1 that is a concentrate comprising water ranging in concentration from about 66 to about 58 percent by weight.

3. The cleaning solution composition of claim 1 wherein the enzyme system comprises at least one protease and at least one amylase.

4. The cleaning solution composition of claim 1 that comprises a boron compound.

5. The cleaning solution composition of claim 3 wherein the boron compound is selected from the group consisting of boronic acid, boric acid, borate, polyborate and combinations thereof and wherein the boron compound is present in a concentration ranging from about 0.2% to about 10% by weight.

6. The cleaning solution composition of claim 1 wherein the system of enzyme stabilizers further comprises an agent selected from the group consisting of calcium salt, alkylene glycol, an alkanolamine, and combinations thereof.

7. The cleaning solution composition of claim 5 wherein the calcium ion concentration ranges from about 0.0% wt, to less than 2.0%, by weight.

8. The cleaning solution composition of claim 3 wherein the protease is present in a concentration ranging from about 0.5 to about 10 percent by weight, and the amylase is present in a concentration ranging from about 0.100 to about 10 percent by weight, respectively, relative to the weight of the concentrate.

9. The cleaning solution composition of claim 2 wherein the nonionic surfactant is present in a concentration ranging from about 1 to about 10 percent by weight, relative to the weight of the concentrate.

10. The cleaning solution composition of claim 1 wherein the nonionic surfactant is low foaming and is selected from the group consisting of a ethoxylates, glucosides, glycerides, glycol esters, glycerol esters, polyglycerol esters, polyglyeerides, polyglycosides, sorbitan esters, sorbitan ester ethoxylates, sucrose esters, and combinations thereof.

11. The cleaning solution composition of claim 10 wherein the ethoxylate is selected from the group consisting of alcohol ethoxylates, mono alkanolamide ethoxylates, fatty amine ethoxylates, fatty acid ethoxylates, ethylene oxide/propylene oxide copolymers, alkyl phenol ethoxylates, and combinations thereof.

12. The cleaning solution composition of claim 1 that comprises a nonionic surfactant comprises a polyoxypropylene - polyoxyethylene block copolymer of a linear alcohol.

13. The cleaning solution composition of claim 1 wherein the solvent system comprises at least one alkanol and at least one alkanolamine, wherein the alkanol is soluble or miscible with water and lipids, and comprises a C₁ to C₁₀ alkyl group that is straight or branched, substituted or non-substituted.

14. The cleaning solution composition of claim 1 that comprises an alkylene glycol.

15. The cleaning solution composition of claim 13 wherein the alkanolamine is selected from the group consisting of a monoalkanolamine, a dialkanolamine, a trialkanolamine, an alkylalkanolamine and combinations thereof.

16. The cleaning solution composition of claim 2 wherein the alkanolamine is triethanolamine, in a concentration ranging from about 1% to about 10% by weight.

17. The cleaning solution composition of claim 2 wherein the metal corrosion inhibitor is present in a concentration ranging from about 0.050 to about 1 percent, by weight

18. The cleaning solution composition of claim 1 further comprising components selected from the group consisting of at least one colorant, at least one perfume, at least one pH indicator, and combinations thereof.

19. A working cleaning solution comprising the cleaning solution concentrate of claim 2, diluted with water to a percentage ranging from about 85 to about 0.500 percent by weight.

20. A method of preparing the cleaning solution concentrate of claim 1 comprising: adding to water with continuous mixing, at least one nonionic surfactant, the water-miscible solvent system, and the system of enzyme stabilizers and stirring until all materials are dissolved or dispersed, in any order suitable for effective dispersion into the water

21. A method of cleaning objects or implements in need thereof by contacting said objects or implements with an effective amount of the cleaning solution of claim 1, for a sufficient time to remove substantially all undesirable foreign matter, and then removing the cleaning solution from said instruments.
